(19) United States
(12) Patent Application Publication
(10) Pub. No.: US 2005/0241365 A1
(43) Pub. Date: Nov. 3, 2005

(54) Transducer testing

(75) Inventor: Kenneth Frank Palmer, Edinburgh (DE)

Correspondence Address: CROWELL & MORING LLP;INTELLECTUAL PROPERTY GROUP, P.O. BOX 14300, WASHINGTON, DC, 20044-4300, US

(73) Assignee: BAE SYSTEMS PLC, LONDON (GB)

(21) Appl. No.: 10/513,597

(22) PCT Filed: Apr. 28, 2003
(86) PCT No.: PCT/GB03/01791

§ 371 Date: Nov. 5, 2004

(30) Foreign Application Priority Data
May 8, 2002 (GB) 0210486.7

(51) Int. Cl. G01N 29/00

(52) U.S. Cl. 73/1.82

(57) ABSTRACT

Described herein is a method and apparatus for testing transducers either as single devices or in phased arrays. The apparatus includes a device which is housed in a casing (12) and comprises three polyurethane layers (15, 16, 17) each having different acoustic characteristics. A detector array (14) is located between two of the layers (15, 16). Means are also provided for clamping the device against a transducer to be tested to ensure good contact. Depending on the test mode of the transducer, either the transducer or the detector array are driven to provide signals which are detected by the other.

The present invention relates to improvements in or relating to transducer testing. The present invention is more particularly concerned with the testing of transducers, phased arrays and towed arrays of such transducers which are frequently used in underwater applications, and in particular, though not exclusively, in the frequency range from 500 Hz to 75 kHz.

The usual method of testing such transducers, phased arrays and towed arrays involves immersing the transducer, phased and towed array in a large volume of water which simulates normal operating conditions thereby presenting the transducer, phased or towed array with the normal acoustic impedance which they will experience in the medium in which they are intended to operate, which is typically water. Typical facilities would be large water tanks, reservoirs or open water sea/ocean/fjord ranges, so that testing is time-consuming, unwieldy and expensive.

One method which has been proposed for overcoming the problems of testing such transducers and phased arrays of transducers utilises acoustic loading rods which are dimensioned to simulate the individual acoustic impedance that a transducer would experience in actual operation. Such a method is described in GB-A-2 237 701.

However, this approach may be problematic as the faces of the phased arrays and of the transducers in such arrays which are to be tested are coated in such a way that there can be no direct contact between the active face of the transducer and the acoustic loading rod.

Furthermore, in the case of towed arrays, a restriction is encountered as different loading rods are in general required for different designs of transducer forming part of the towed array.

It is therefore an object of the present invention to provide a method and apparatus which provides a solution for testing transducers and phased or towed arrays of such transducers which overcome the above disadvantages.

In accordance with a first aspect of the present invention, there is provided a method of testing modes of operation of a transducer, the method comprising:
a) placing the transducer into contact with a block of graded impedance matching and sound absorbent material which includes a plurality of bi-directional piezoelectric transducer elements;
b) driving said plurality of piezoelectric transducer elements in accordance with the mode to be tested; and
c) measuring properties of said transducer or said plurality of piezoelectric transducer elements in accordance with the mode being tested.

When the mode being tested is the admittance mode, step b) comprises driving said plurality of piezoelectric transducer elements to provide a bulk match which simulates the normal acoustic impedance presented to the transducer in the medium in which it is intended to operate, and step c) comprises measuring properties of said transducer.

When the mode being tested the receive mode, step b) comprises driving said plurality of piezoelectric transducer elements by variable phased drive electronics so as to simulate steered acoustic plane waves propagating under test, and step c) comprises measuring the receiver field sensitivity of the transducer. Ideally, step c) comprises measuring the amplitude and phase of the receiver field.

When the mode being tested is the transmit mode, the method further comprises driving said transducer, and using said plurality of piezoelectric transducer elements in said block to measure the amplitude and phase of the acoustic wave emanating from the transducer under test.

It is an advantage of the present invention that the above method can be used to test more than one of said transducers at any one time. Advantageously, said more than one of said transducers forms at least a part of a phased array of said transducers.

In one embodiment of the present invention, the method of testing the admittance and/or receive and/or transmit modes of operation of transducers and phased arrays of transducers comprises placing the transducer or phased array of transducers into contact with a block of graded impedance matching and sound absorbent material. When testing the admittance mode of transducers and phased arrays of transducers, said block provides a bulk match to simulate the normal acoustic impedance presented to them in the medium in which they are intended to operate. When testing the receive mode, driving a plurality of bi-directional piezoelectric transducer elements mounted within said block by variable phased drive electronics so as to simulate steered acoustic plane waves propagating under test, and measuring the receiver field (amplitude and phase) sensitivity of the transducers and phased arrays of transducers. When testing the transmit mode, driving said transducers and phased arrays of transducers, and using said plurality of bi-directional piezoelectric transducer elements to measure the amplitude and phase of the acoustic wave emanating from the transducer or phased array of transducers under test.

In accordance with a second aspect of the present invention, there is provided apparatus for testing the modes of operation of a transducer, the apparatus comprising:
a block of graded impedance matching and sound absorbent material for the placing of said transducer in intimate contact therewith;
a plurality of bi-directional piezoelectric transducer elements mounted within said block; and
means for driving said piezoelectric transducer elements or said transducer in accordance with the desired test mode, said transducer or said piezoelectric transducer elements measuring properties in accordance with the test mode.

Advantageously, the block comprises two or more layers of material, each layer having different acoustic characteristics to the other. It is preferred that the boundary between said two layers of material has a profile in the shape of a saw-tooth.

Alternatively, the block comprises a continuously graded material.

In one embodiment, the block comprises three layers, the upper layer of which retains said plurality of piezoelectric transducer elements against a central layer.

It is preferred that, when testing the receive mode of said transducer, said means for driving said plurality of piezoelectric transducer elements comprises variable phased drive electronics which simulates steered acoustic plane waves propagating under test, and the property of said transducer measured is its receiver field sensitivity. Ideally, the receiver field sensitivity of said transducer is measured in terms of amplitude and phase.

Furthermore, when testing the transmit mode of said transducer, said means for driving said piezoelectric transducer elements or said transducer drives said transducer and said plurality of piezoelectric transducer elements measure the amplitude and phase of the acoustic wave emanating from said transducer under test.

Advantageously, said apparatus tests more than one of said transducers at a time, and it is preferred that said more than one of said transducers forms at least a part of a phased array of said transducers.

Apparatus for testing the admittance and/or receive and/or transmit modes of operation of transducers and phased arrays of transducers is also provided. The apparatus comprises a block of graded impedance matching and sound absorbent material for the placing of said transducers and phased arrays of transducers in intimate contact therewith; and a plurality of bi-directional piezoelectric transducer elements mounted within said block. When using said apparatus to test the receive mode, said plurality of piezoelectric transducer elements are driven by variable phased drive electronics to simulate steered acoustic plane waves propagating under test, and the receiver field (amplitude and phase) sensitivity of the transducer and phased array of transducers are measured. When using said apparatus to test the transmit mode, said transducers and phased arrays of transducers are driven, and said plurality of bi-directional piezoelectric transducer elements are used to measure the amplitude and phase of the acoustic wave emanating from the transducer or phased array of transducers under test.

In accordance with a third aspect of the present invention, there is provided a method of testing the receive mode of operation of a towed array comprising a plurality of hydrophones, said method comprising the steps of:
a) drawing said towed array through a block of graded impedance matching and sound absorbent material;
b) driving a plurality of bi-directional piezoelectric transducer elements mounted within said block to simulate steered acoustic plane waves propagating under test; and
c) measuring the receiver field sensitivity of said towed array.

It is preferred that step b) comprises driving said piezoelectric transducer elements using variable phased drive electronics, and step c) measures amplitude and phase of said towed array.

In accordance with a second embodiment of the present invention, a method of testing the receive mode of operation of towed arrays of hydrophones is described. The method comprises drawing said towed array through a block of graded impedance matching and sound absorbent material and driving a plurality of bi-directional piezoelectric transducer elements mounted within said block using variable phased drive electronics to simulate steered acoustic plane waves propagating under test. Measurements of the receiver field (amplitude and phase) sensitivity of the towed array are then taken.

In accordance with a fourth aspect of the present invention, there is provided apparatus for testing the receive mode of operation of a towed array comprising a plurality of hydrophones, the apparatus comprising:
a block of graded impedance matching and sound absorbent material enclosing a suitable cylindrical orifice through which said towed array can be drawn;
a plurality of bi-directional piezoelectric transducer elements mounted within said block suitably placed with respect to said orifice;
drive means for driving said piezoelectric transducer elements to simulate steered acoustic plane waves propagating under test; and
means for measuring the receiver field sensitivity of said towed array.

Preferably, said block comprises two layers concentrically arranged around said orifice. In one embodiment, said two layers have a boundary which has a profile which is substantially shapes as a saw tooth.

Preferably, said drive means comprises variable phased drive electronics.

An apparatus for testing the receive mode of operation of towed arrays is provided which comprises a block of graded impedance matching and sound absorbent material which encloses a suitable cylindrical orifice through which a towed array of hydrophones can be drawn. A plurality of bi-directional piezoelectric transducer elements is mounted within said block. The block which is suitably placed with respect to said orifice such that when variable phased drive electronics are applied to the piezoelectric transducer elements to simulate steered acoustic plane waves propagating under test, the receiver field (amplitude and phase) sensitivity of the towed array can be measured.

For a better understanding of the present invention, reference will now be made, by way of example only, to the accompanying drawings in which:

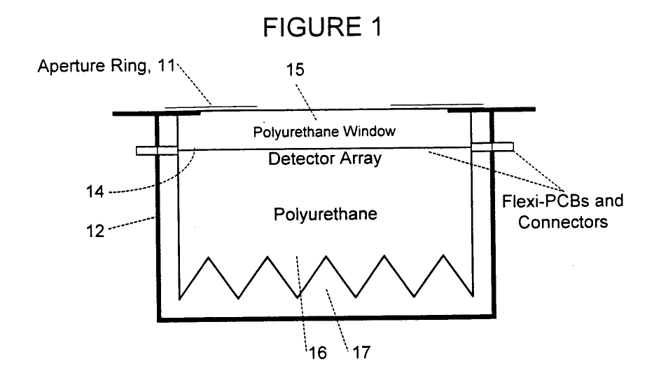

FIG. 1 is a side section through test apparatus for testing the admittance and/or receive and/or transmit modes of operation of transducers and phased arrays of transducers;

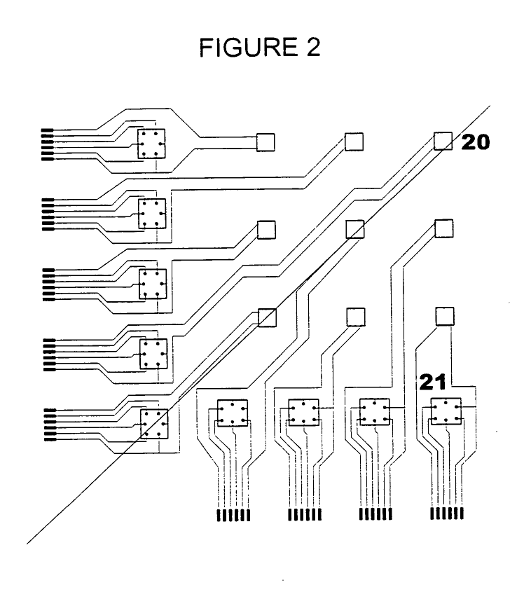

FIG. 2 shows an example of the plurality of bi-directional piezoelectric transducer elements which would be incorporated into said blocks of graded impedance matching and sound absorbent material;

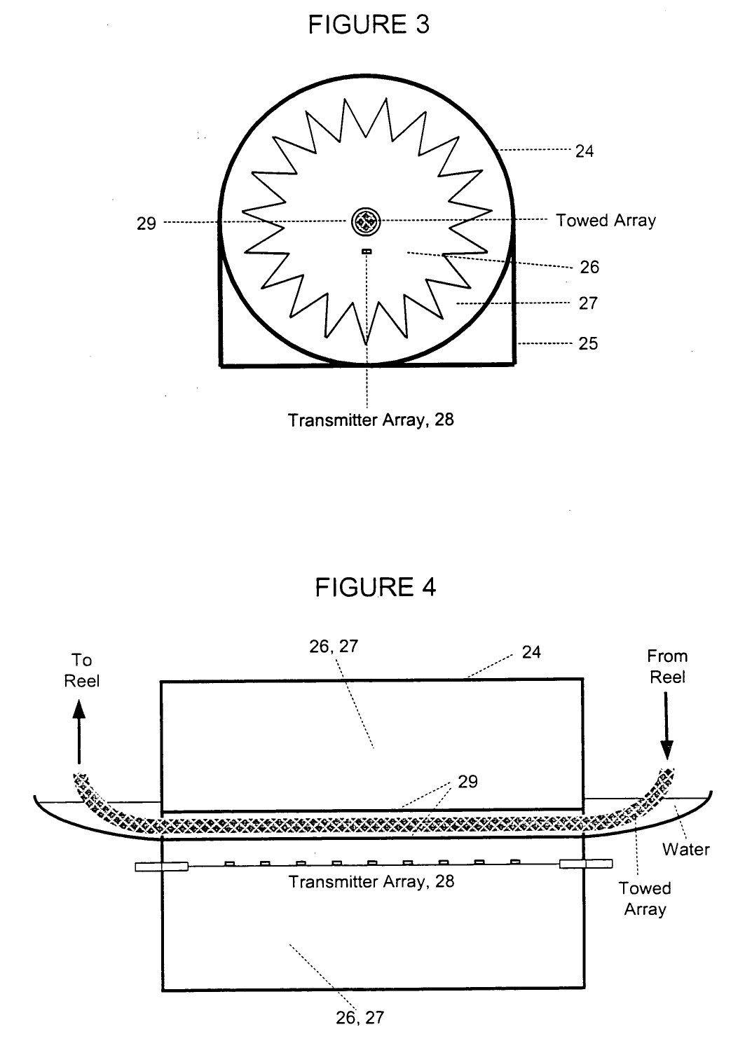

FIG. 3 is a cross section through a first embodiment of test apparatus for testing the receive mode of operation of towed arrays; and

FIG. 4 is a side section through a second embodiment of test apparatus for testing the receive mode of operation of towed arrays.

Referring initially to FIG. 1, a device for testing transducers and phased arrays of transducers, and particularly transmit/receive transducers singly or mounted as a planar array, is shown. It will be appreciated that although a single device is shown, several of such similar devices will be required for testing a plurality of transducers mounted in a planar array, or one such device could be used to test each transducer in the array in turn. For simplicity, the operation of the device of FIG. 1 will be described with reference to testing a single transducer, but it will readily be understood that the description can be extended to include testing a plurality of such single transducers forming at least a part of an array.

The device shown in FIG. 1 comprises a main body contained within an outer housing or casing 12 constructed from a rigid material such as steel and formed in two flanged parts which are held together by bolts (not shown). An aperture ring 11 defines a window against which a transducer to be tested can be placed for testing. The aperture ring 11 provides a means for achieving intimate contact between the transducer as it is necessary to apply pressure to cause such intimate contact between the mating faces. The pressure is applied from a suitable mounting facility (not shown) fitted to or forming part of the transducer to be tested and the top flanged portion of the housing or casing 12 (the pressure mechanism also not shown).

The outer housing 12 is filled to create a chamber of polyurethane material which has some differing properties according to the various regions indicated by numerals 15, 16 and 17. One important feature of these polyurethane materials is that their characteristic impedance (product of density and velocity of sound) is similar to that for the medium in which the transducer is intended to operate. A second important feature of the polyurethane region 15 is that it has a very low level of acoustic absorption for example 0.2 dB per mm. By way of comparison, the material utilised in the device described in GB-A-2 237 701 discussed above has an absorption of the order of 2 dB per mm with a resultant significant loss of sensitivity of measurement capability.

The ‘window’ material 15 of the present invention is an elastomeric polyurethane obtained from a polymeric methylene diphenyl diisocyanate or equivalent reacted with a polyol. The polyol is di- or multifunctional and is molar mass adjusted to give the required acoustic and mechanical properties. The polyurethane formulations may contain a suitable chain extender, for example (1,4)butane diol, and may incorporate an appropriate catalyst.

A list of chemicals required for making the elastomeric polyurethane (absorber material) is shown Table 1 below.

TABLE 1

| Material | Description |
|---|---|
| Polyol | Daltocel F438 |
| Diisocyanate (polymeric MDI) | Suprasec 5005 |
| Chain extender | 1,4 butane diol |
| Catalyst | Thorcat 535 |
| Silicon nitride (powder) | 325 mesh, predominantly beta phase, |
| | CAS No: 12033-89-5. Product No. |
| | 248622. Purity Grade: Extra Pure. |

Technical descriptions for these polyurethane reactants and filler are given below:

Polyol: Daltocel F438:

This product is initiated with a diethylene glycol glycerol mixture. It is then extended with propylene oxide and capped with a 20.6% ethylene oxide tip. The resultant product is approximately 2.2 functionality and provides a good quality elastomer with a sharp cure when well formulated. Viscosity 900 cp at 25° C., OH value 35.

Chain Extender: 1,4 butane diol:

1,4 butane diol is extensively used as a chain extender in polyurethane elastomers. However, the product is prone to crystallisation at temperatures below 10° C. in blends and hence is normally kept in a warm environment. OH value 1246, Equivalent weight 45.

Diisocyanate: Suprasec 5005:

This product is commonly known as Polymeric MDI. It has an average functionality of 2.7, an NCO content of 30.7% and a viscosity of 230 cp at 25° C. In the formulation given herein, it is used at approximately 25% above the stoichiometric ratio.

Catalyst: Thorcat 535:

This is a mercury based catalyst which favours the urethane reaction over the water isocyanate reaction and is hence extensively used in elastomers.

Silicon Nitride: Si₃N₄:

Most importantly, silicon nitride is hydrophobic and significant quantities can be incorporated without adversely affecting the processing limitations. Silicon nitride occurs in two forms, α and β, with similar crystal structures but with the following cell dimensions:
For α: a=7.753 Å, c=5.623 Å;
And for β: a=7.603 Å, c=2.906 Å.

The β phase is the more stable high temperature phase and no convincing demonstration of the β→α transformation has been reported. The silicon nitride specified above is predominantly β phase with a particle size quoted as 325 mesh.

It will be appreciated that attention is to drawn to the various manufacturers' Health and Safety Data Sheets for the above products, which must be followed. In particular, it is imperative that fumes of the diisocyanate which contain a polymeric MDI are not inhaled.

A typical formulation for a polyurethane material is shown in Table 2 below.

TABLE 2

| Material | Percentage by weight |
|---|---|
| Polyol | 35.4 |
| Diisocyanate | 28.7 |
| Chain extender | 6.4 |
| Catalyst | 0.1 |
| Silicon nitride (powder) | 29.4 |

Where changes are required to the absorption level for a particular application, the chain extender level should be varied in the first instance, a change of +0.5% causing a small but useful decrease in absorption coefficient.

It will be appreciated that the composition of the polyurethane material may be varied to achieve a range of absorption coefficients in accordance with a particular application.

It is important that the polyurethane region 16 of the device shown in FIG. 1 has a similar characteristic impedance to that for the polyurethane material region 15, but with a higher absorption coefficient. As discussed above, a variation in the absorption coefficient is achieved by varying the composition of the polyurethane formulation used for the region 15.

Similarly, it is important that the polyurethane region 17 of the device has a similar characteristic impedance to that for the polyurethane material region 16, but with an even higher absorption coefficient. Again this is achieved by varying the composition of the polyurethane formulation used for the region 15 and 16. Dependent upon the frequency range required, the dimensions for each region are selected such as will achieve the entire chamber acting as an efficient anechoic absorber with reflections reduced to a minimum. To this end the boundary between the materials 16 and 17 may have a saw-tooth cross-section as shown in FIG. 1.

Alternatively, the precise selection of elastomeric polyurethane composition for regions 16 and 17 may include the use of either a number of further discrete layers within each region each with differing properties in a sequential manner, or a continuously graded material. Dependent upon the dimensions selected, the working frequency range would be 500 Hz to 75 kHz, or some frequency band within that range applicable to the particular selection of test subject transducer or array of transducers.

Situated at the boundary between polyurethane materials 15 and 16 is a 2D planar array which primarily comprises a plurality of bi-directional piezoelectric transducer elements. This is in contrast to the device described in GB-A-2 237 701 which includes a detector film made from a copolymer piezoplastic. It was found that the array described in GB-A-2 237 701 has poor measurement capability due to very poor sensitivity. This is not only because of absorption loss in the window as detailed above, but also because of the poor performance sensitivity of the small areas of active piezoplastic employed, in conjunction with low capacitance of such device and subsequent cross coupling of signals due to random capacitive effects which further degrade performance. The piezoplastic has a poor output dₕ in the hydrostatic condition which is relevant to this application.

The present invention addresses these difficulties by employing a detector array 14 (FIG. 1) manufactured using flexi PCB technology and incorporating individual ceramic elements as shown by way of example in the plan view of FIG. 2. The number and configuration of elements will be determined by the shape and size of the intended test subjects and their operating frequencies. There can be any number of elements 20 within the array, with nine elements shown by way of example, and the spacing of these elements will normally be equi-distant and of a distance rather less than the half wavelength at the maximum frequency of interest. The actual size of the element 20 will be small compared with the spacing distance so that each element approximates to a point source. An example of ceramic material used will be lead zirconate or lead titanate solid ceramic or a 0-3 composite comprising a modified lead titanate powder distributed in a neoprene polymer matrix, all of which have a piezoelectric output dₕ five times that for piezoplastic.

Further improvement in performance is provided by the provision of pre-amplifiers 21 onto the flexi-PCB, there being one pre-amplifier per transducer element. In order to reduce parasitic capacitance the electronics (of the pre-amplifier) is kept small and situated close to each transducer element. The array has in-plane screening of the signals by always placing an earth line next to the signal line from the element. There is also a transmit line to drive each element when required. Each pre-amplifier is given sufficient gain such as ×100 to increase the signal level so that other electromagnetically induced signals would be low. An earth plane can be incorporated if required as all the tracks can be incorporated on one side of the flexi-PCB. The polyimide material is selected to minimise cross coupling between the piezoelectric transducer elements. The interconnection pattern is applied to the surface of the polyimide using a photolithographic technique. The pre-amplifier circuits are mounted onto the interconnect layer and the piezo-electric transducer elements bonded to the same layer using silver dag. The top contact is made using silver dag to connect a wire to the top of the electrode and solder to connect it to the track. The completed flexi-PCBs are bonded to the top surface of polyurethane material 16 (FIG. 1) using further small quantities of polyurethane material 16.

The polyurethane material 15 is moulded and cured remotely and then bonded on top of the flexi-PCBs using further small quantities of polyurethane material 16.

Electrical connections between the bi-directional piezoelectric transducer elements and external test equipment are made by electrical cables and connectors (not shown) which are mated to the edge connectors (also not shown) contained around the periphery of complete flexi-PCB array 14.

The device described with reference to FIGS. 1 and 2 can be used either as a transmitter tester or a receiver tester. When used in a passive mode the array of piezoelectric transducer elements 20 (FIG. 2) are used to measure the Near Field amplitude and phase of the acoustic wave emanating from the transducer or array under test. Since the geometric spacing of the piezoelectric transducer elements 20 is known, a mathematical algorithm is used to calculate the far field response parameters of the transducer or phased array. Because of the ‘point source’ nature of an individual transducer element 20, the test subject is in the far field of each individual transducer element. Thus, when the plurality of piezoelectric transducer elements are used as transmitters simultaneously having identical amplitudes and phases, they will simulate an incident plane wave arriving at the test subject interface as if it has originated from the far field. This will enable the ‘ahead’ receive sensitivity of the test subject to be measured.

Similarly, by applying phased delays to the plurality of piezoelectric transducer elements, it is possible to simulate incident plane waves arriving at the test subject interface as if they has originated from different angular directions in the far field. This makes it possible to construct far field receive beam plots. The present invention has been used to simulate every point in the far field of test subjects' forward looking 2π steradians, using three degree increments of azimuth and elevation by way of example.

Referring now to FIGS. 3 and 4, apparatus for testing towed arrays is shown, in cross-sectional and side-elevation views respectively.

The apparatus shown in FIGS. 3 and 4 comprises a main body in the form of a cylinder lying on its side and supported by rigid supports 25. The outer housing or casing 24 is constructed from a rigid material such as steel and for example formed in two flanged parts held together by bolts and is filled to create a chamber of polyurethane material. A central hole 29 of suitable diameter runs centrally through the length of the cylinder from the centre of one of the faces to the centre of the other face. A towed array type sonar device (for example, a plurality of hydrophones) can be introduced through this central hole 29 such that the total length of said towed array may be pulled through the hole by reeling the towed array from one transport drum onto another transport drum. Hydrophones contained within said towed array can be tested provided intimate contact to the outer wall of the towed array is achieved and it is important to note that repeatable results cannot be achieved where the test method relies upon the transmission of acoustic pressure waves through a gaseous medium such as air, as is commomly employed.

An essential feature of this invention is that intimate contact is achieved by having the central hole flooded with water prior to the introduction of the towed array. By using suitable sealing mechanisms at both ends of the central hole, the water may be pressurised in accordance with any specific test requirement.

The volume contained between the outer housing 24 and the central hole 29 is filled to create a chamber of polyurethane material which has some differing properties according to the various regions 26 and 27. As discussed above with reference to FIGS. 1 and 2, it is important that the characteristic impedance (product of density and velocity of sound) of the polyurethane materials used is similar to that for the water medium in which the towed arrays are intended to operate.

It is also important that the polyurethane region 26 has a very low level of acoustic absorption for example 0.2 dB per mm. As before, the ‘window’ material 26 of the present invention is an elastomeric polyurethane obtained from a polymeric methylene diphenyl diisocyanate or equivalent reacted with a polyol. The polyol is di- or multifunctional and is molar mass adjusted to give the required acoustic and mechanical properties. The polyurethane formulations may contain a suitable chain extender, for example (1,4)butane diol, and may incorporate an appropriate catalyst. The composition of the polyurethane material may be varied to achieve a range of absorption coefficients as described above with reference to the materials used in the device shown in FIG. 1.

Again, the material in polyurethane region 27 must have similar characteristic impedance to that for the material in polyurethane material region 26, but with a higher absorption coefficient which is achieved by varying the composition of the polyurethane formulation used for the region 26. Dependent upon the frequency range required, the dimensions for each region are selected such as will achieve the entire chamber acting as an efficient anechoic absorber with reflections reduced to a minimum. To this end the boundary between the materials 26 and 27 may have a saw-tooth cross section as shown.

Alternatively, the precise selection of elastomeric polyurethane composition for regions 26 and 27 may include the use of either a number of further discrete layers within each region each with differing properties in a sequential manner, or a continuously graded material. Dependent upon the dimensions selected, the working frequency range would be 500 Hz to 10 kHz, or some frequency band within that range applicable to the particular towed array test subject hydrophone.

Situated within the polyurethane material 26 is a linear transmitter array 28 primarily comprising a plurality of transmitter elements similar to the bi-directional piezoelectric transducer elements 20 described in FIG. 2. There can be any number of elements within the transmitter array 28 with nine elements shown by way of example, and the spacing of these elements will normally be equi-distant and of a distance rather less than the half wavelength at the maximum frequency of interest. Other features of the transmitter array will be consistent with those described above with reference to FIG. 2.

Although the apparatus just described can be used either as a transmitter tester or a receiver tester, since the normal application of towed array devices is as receiver only, the array 28 will always be used as a transmitter. Because of the ‘point source’ nature of each individual element within the array 28 the test subject is in the far field of each individual transducer element. Thus when the plurality of piezoelectric transducer elements are used as transmitters simultaneously having identical amplitudes and phases, they will simulate an incident plane wave arriving at the test subject interface as if it has originated from the far field. This will enable the ‘normally incident’ receive sensitivity of the test subject to be measured.

Similarly, by applying phased delays to the plurality of piezoelectric transducer elements, it is possible to simulate incident plane waves arriving at the test subject interface as if they has originated from different angular directions from −90° to +90° from normal incidence. It is thus possible to construct far field receive beam plot, in a single plane. By the inclusion of further linear arrays 28 within the volume 26 it is also possible to verify the omnidirectional responses of the towed array hydrophones.

1-22. (canceled)

23. Apparatus for testing the modes of operation of a transducer, the apparatus comprising:
a block of graded elastomeric polyurethane material being placed in intimate contact with transducer, said block having impedance characteristics matched to that of said transducer and including a first region, a second region and a third region: said second region having a higher acoustic absorption coefficient than said first region, and said third region having a higher acoustic absorption coefficient than said second region;
a plurality of bi-directional piezoelectric transducer elements mounted within said block; and
means for driving said piezoelectric transducer elements or said transducer in accordance with the desired test mode, said transducer or said piezoelectric transducer elements measuring properties in accordance with the test mode.

24. Apparatus according to claim 23, wherein said material in said second and third regions comprises a plurality of discrete layers.

25. Apparatus according to claim 23, wherein said material in said second and third regions comprises a continuously graded material.

26. Apparatus according to claim 23, wherein said plurality of piezoelectric transducer elements is retained between said first region and said second region.

27. Apparatus according to claim 23, wherein said second region and said third region have a boundary therebetween with a profile in the shape of a saw-tooth.

28. Apparatus according to claim 23, wherein, when testing the receive mode of said transducer, said means for driving said plurality of piezoelectric transducer elements comprises variable phased drive electronics which simulates steered acoustic plane waves propagating under test, and the property of said transducer measured is its receiver field sensitivity.

29. Apparatus according to claim 28, wherein the receiver field sensitivity of said transducer is measured in terms of amplitude and phase.

30. Apparatus according to claim 23, wherein, when testing the transmit mode of said transducer, said means for driving said piezoelectric transducer elements or said transducer drives said transducer and said plurality of piezoelectric transducer elements measure the amplitude and phase of the acoustic wave emanating from said transducer under test.

31. Apparatus according to claim 23, wherein, when the mode being tested is the admittance mode, said means for driving said plurality of piezoelectric transducer elements provides a bulk match which simulates the normal acoustic impedance presented to the transducer in the medium in which it is intended to operate.

32. Apparatus according to claim 23, wherein said apparatus tests more than one of said transducers at a time.

33. Apparatus according to claim 32, wherein said more than one of said transducers forms at least a part of a phased array of said transducers.

34. Apparatus according to claim 23, wherein said means for driving said piezoelectric transducer elements or said transducer comprises variable phased drive electronics.

35. A method of testing modes of operation of a transducer using the apparatus according to claim 23, the method comprising:
a) placing the transducer into contact with said block of graded elastomeric polyurethane material;
b) driving said plurality of piezoelectric transducer elements in accordance with the mode to be tested; and
c) measuring properties of said transducer or said plurality of piezoelectric transducer elements in accordance with the mode being tested.

36. Apparatus for testing the receive mode of operation of a towed array comprising a plurality of hydrophones, the apparatus comprising:
a block of graded elastomeric polyurethane material enclosing a suitable cylindrical orifice through which said towed array can be drawn, said block having impedance characteristics matched to that of said towed array and including at least a first region and a second region: said second region having a higher acoustic absorption coefficient than said first region;
a plurality of bi-directional piezoelectric transducer elements mounted within said block suitably placed with respect to said orifice;
drive means for driving said piezoelectric transducer elements to simulate steered acoustic plane waves propagating under test; and
means for measuring the receiver field sensitivity of said towed array.

37. Apparatus according to claim 36, wherein said material in said first and second regions comprises a plurality of discrete layers.

38. Apparatus according to claim 36, wherein said material in said first and second regions comprises a continuously graded material.

39. Apparatus according to claim 36, wherein said plurality of piezoelectric transducer elements is situated within said first region.

40. Apparatus according to claim 36, wherein said first region and said second region have a boundary therebetween with a profile in the shape of a saw-tooth.

41. Apparatus according to claim 36, wherein said drive means comprises variable phased drive electronics.

42. A method of testing the receive mode of operation of a towed array comprising a plurality of hydrophones using the apparatus according to claim 36, said method comprising the steps of:
a) drawing said towed array through said block of graded elastomeric polyurethane material;
b) driving a plurality of bi-directional piezoelectric transducer elements mounted within said block to simulate steered acoustic plane waves propagating under test; and
c) measuring the receiver field sensitivity of said towed array.

43. A method according to claim 42, wherein step b) comprises driving said piezoelectric transducer elements using variable phased drive electronics.

44. A method according to claim 42, wherein step c) measures amplitude and phase of said towed array.
